(19) United States
(12) Patent Application Publication
(10) Pub. No.: US 2020/0002983 A1
(43) Pub. Date: Jan. 2, 2020

(54) Telescoping Door Barricade Device and Related Methods

(71) Applicant: Ron Breland, Cranston, RI (US)

(72) Inventor: Ron Breland, Cranston, RI (US)

(21) Appl. No.: 16/448,411

(22) Filed: Jun. 21, 2019

Related U.S. Application Data
(60) Provisional application No. 62/691,749, filed on Jun. 29, 2018.
(60) Provisional application No. 62/744,290, filed on Oct. 11, 2018.

(51) Int. Cl. E05C 19/00

(52) U.S. Cl. CPC E05C 19/003

(57) ABSTRACT

Barricading devices and methods are described herein for various door configurations. The disclosed barricades can protect the occupants of a room and/or structure with an outward opening door, an inward opening door, and/or double doors from any threatening situation, such as an active shooter, deranged intruder, disgruntled patient or customer, etc., quickly and easily in seconds. The disclosed barricade devices include spring-loaded telescoping arms that, when activated, extend outwardly over at least part of the adjacent walls to ensure that the door cannot move relative to the adjacent walls.

### CROSS-REFERENCE TO RELATED APPLICATIONS

This application claims priority from U.S. Provisional Patent Application Ser. No. 62/691,749, titled “Telescopic Door Barricade Device and Related Methods” filed Jun. 29, 2018 and U.S. Provisional Patent Application Ser. No. 62/744,290, titled “Telescopic Door Barricade Devices and Related Methods” filed Oct. 11, 2018, the contents of each of which are incorporated by reference herein.

### BACKGROUND

Over the last 20 years there have been an increasing amount of mass shootings in the United States, many of which have occurred in schools, movie theaters, churches and even military bases. Also, according to the U.S. Department of Justice there are 1.03 million home invasions that occur each year. The need for a fast and effective way of barricading a room and/or structure is more important now than at any other time in our history. The barricades described herein can address this need as well as other possible needs.

### SUMMARY

The presently disclosed devices and methods can protect the occupants of a room and/or structure with an outward opening door, an inward opening door, and/or double doors from any threatening situation, such as an active shooter, deranged intruder, disgruntled patient or customer, etc., quickly and easily in seconds. As described in more detail below, distinct barricade configurations are disclosed for both outward-opening and inward-opening doors. The barricade configures described herein each include telescoping features.

In the case of a telescoping door barricade for inward opening doors, the disclosed devices can effectively deter a person from entering the home from an outside door, thereby making the home a safer place. Furthermore, in another aspect, the disclosed telescoping door Barricade for inward opening doors can protect the occupants of a home, apartment, or office from a hostile act by an assailant. When activated, the disclosed devices will stop a door from opening even when someone tries to kick in or batter in the door, providing the occupants time to call the police. The telescoping arms of the disclosed devices can secure the door to the wall and can be effectively activated within seconds manually or by electronic activation. The disclosed barricades can be used to secure corridors when linked to metal detectors, sensing devices for metal, sound, select sounds, central command center, not only to protect a room but also to alter passage and isolate an intruder. The device when electronically activated can be integrated with an automatic door closing system which may be remote controlled. The disclosed telescoping door barricade devices can be integrated into new doors at the factory or any existing door.

As used throughout the subject disclosure, the “telescoping” is understood to be synonymous and to refer to features that slide out from another part, thereby lengthening the object from its rest state.

### BRIEF DESCRIPTION OF THE DRAWINGS

FIG. 1 shows an engineering plan drawing of an exemplary telescoping door barricade for an outward-opening door from a top view;

FIG. 2 shows the exemplary telescoping door barricade for an outward-opening door shown in FIG. 1 from a bottom perspective view;

FIG. 3 shows the exemplary telescoping door barricade for an outward-opening door shown in FIG. 1 from a bottom view;

FIG. 4 shows a locking portion of an exemplary telescoping door barricade;

FIG. 5 shows an exemplary outer door adapter device;

FIG. 6 shows an exemplary inner door adapter device;

FIG. 7 shows the exemplary telescoping door barricade shown in FIGS. 1-3 interfacing with a hex tool;

FIG. 8 shows the exemplary telescoping door barricade shown in FIGS. 1-3 and 7 in a stored or rest position, with the telescoping locking arms stored inside the frame of the locking portion;

FIG. 9 illustrates a perspective view of an exemplary door bracket for an inward-opening door, in accordance with some embodiments of the subject disclosure;

FIGS. 10A and 10B shows an exemplary locking bar assembly of a barricade for an inward-opening door, with FIG. 10A showing a perspective view of the locking bar assembly and FIG. 10B showing an exploded view of the locking bar assembly;

FIG. 11 illustrates an exemplary arm of the locking bar assembly shown in FIGS. 10A and 10B;

FIG. 12 illustrates an exemplary left wall bracket to receive the exemplary arm shown in FIG. 11;

FIG. 13A illustrates as exemplary left wall corner bracket and FIG. 13B illustrates an exemplary right wall corner bracket;

FIGS. 14A and 14B illustrate an exemplary locking bar assembly (as shown in FIGS. 10A and 10B) mounted to a door, with FIG. 14A showing the locking bar assembly in an unlocked position and FIG. 14B showing the locking bar assembly in a locked position;

FIG. 15 illustrates an exemplary barricade for double doors, in accordance with some embodiments of the subject disclosure;

FIG. 16 illustrates an exemplary left door receiving bracket; and

FIG. 17 illustrates an exemplary barricade device for double door, in accordance with some embodiments of the subject disclosure.

The accompanying drawings, which are incorporated in and encompass a portion of this specification, illustrate embodiments of the disclosure and with the detailed description, serve to further explain features of the presently disclosed devices and methods. The embodiments shown in the drawings contain possible measurements, but it should be understood that the disclosure is not limited to the exact arrangements and specifications shown in the drawings. For a fuller understanding of the nature and advantages of the present disclosure, reference should be made to the specification as a whole, along with accompanying drawings.

### DETAILED DESCRIPTION

The disclosed door barricade devices may be used to effectively deter unwanted entry to any outward opening door, inward opening door, and/or double doors. Barricade configurations specifically designed for outward-opening doors and inward-opening doors are described in detail in the following sections. The disclosed barricade devices include telescoping features and, throughout the subject disclosure, the disclosed devices may be referred to “telescoping door barricade” devices or similar.

In the case of a telescoping door barricade for outward opening doors, the device may be permanently mounted anywhere on the inside face of an outward opening door. In select embodiments, the barricade for an outward opening door is installed towards a bottom potion of the door (e.g., attached to a bottom edge of the door). The telescoping door barricade will, in many cases, defend against any attempt to open by an intruder manually. The telescoping door barricade may fold down, when needed, and may be activated by pushing a release mechanism and telescoping arms are extended immediately to lock against the wall, making it impossible to open door from the outside. In some embodiments, the telescoping door barricade can be activated by three simple actions: (1) close the door, (2) fold down the device, (3) push the release bar to secure the door.

In the case of a telescoping door barricade for inward opening doors and double doors, the barricade device may be permanently mounted to the inside of the door parallel to the floor. There are at least two mounting positions for the wall brackets for single doors of any width: (1) the vertical wall brackets can be mounted to the wall studs below the door handle with screws (e.g., 3″ screws), or (2) the 90 degree wall brackets may be mounted to the wall studs at the bottom of the door jamb and the floor plate (e.g., with 3″ screws). The disclosed telescoping door barricade mounting for double doors can be attached to both doors, wherein the locking portion of the barricade is mounted on the right door and the receiving bracket on the left door. The telescoping door barricade for inward opening double doors can be either mounted at the bottom of the door or the middle of the door, just below the conventional door locks. The telescoping door barricade may be activated by pushing a release bar allowing the telescoping arms to extend into the wall brackets securing the door to the wall or locking both doors together.

The telescoping door barricade for inward opening single and double doors can allow occupants of a home, apartment or office to effectively lock any inward opening doors from an outside intruder. The device when activated on single doors locks the door to the wall preventing the door from opening. The double door application locks both doors together, preventing opening the doors either inward or outward, giving time for the occupants to call the police.

### Exemplary Devices for Outward-Opening Doors

Telescoping door barricades for outward-opening doors are described herein. The disclosed telescoping door barricade devices can allow occupants of a room and/or structure to quickly and effectively barricade any outward opening door with just three simple actions: (1) close the door; (2) fold down the Telescoping Door Barricade; and (3) push the release lever.

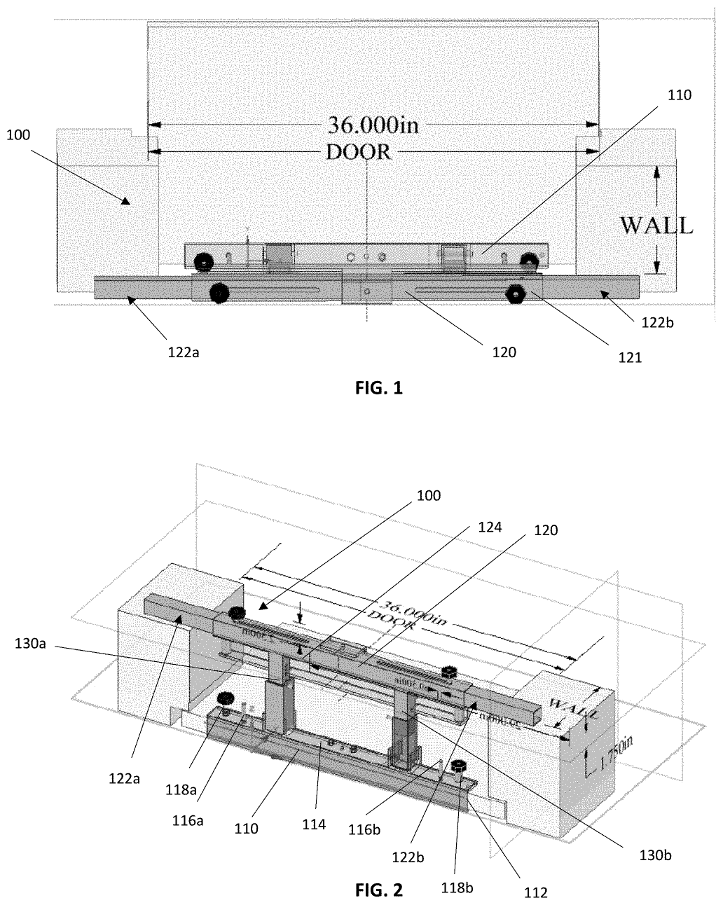

FIG. 1 shows an exemplary telescoping door barricade 100 for an outward-opening door. As shown in FIG. 1, the barricade 100 is mounted to the inside of a 36″ wide door and illustrated in a locked (as opposed to an unlocked) position. As shown in FIG. 1, the barricade 100 includes a mounting portion 110 configured to be fixedly mounted on a door and a locking portion 120 connected to the mounting portion 110. The mounting portion 110 may be connected to the locking portion 120 in any suitable manner, including by welding, bolting, or other connective features. The mounting portion 110 may include holes through which screws or other fasteners may be driven to secure the mounting portion 110 to a desired door.

As shown in FIG. 1, the locking portion 120 includes a frame 121 with two telescoping locking arms 122a, 122b (i.e., a first telescoping arm 122a and a second telescoping arm 122b) retained therein. When the barricade 100 is in an unlocked position, the telescoping arms 122a, 122b are retained inside the frame 121 but when the barricade is in a locked position, each telescoping arm 122a, 122b extends beyond the door and past a portion of the adjacent wall when the barricade 100. Specifically, the first telescoping arm 122a is arranged to extend from the frame 121 in a first direction and the second telescoping arm 122b is arranged to extend from the frame 121 in a second direction, which is opposite from the first direction. When in a locked position, as shown in FIG. 1, the barricade 100 makes the door to which it is attached effectively connected to the wall. In this way, the door to which the barricade 100 is attached cannot be opened from the outside when the barricade 100 is activated or locked.

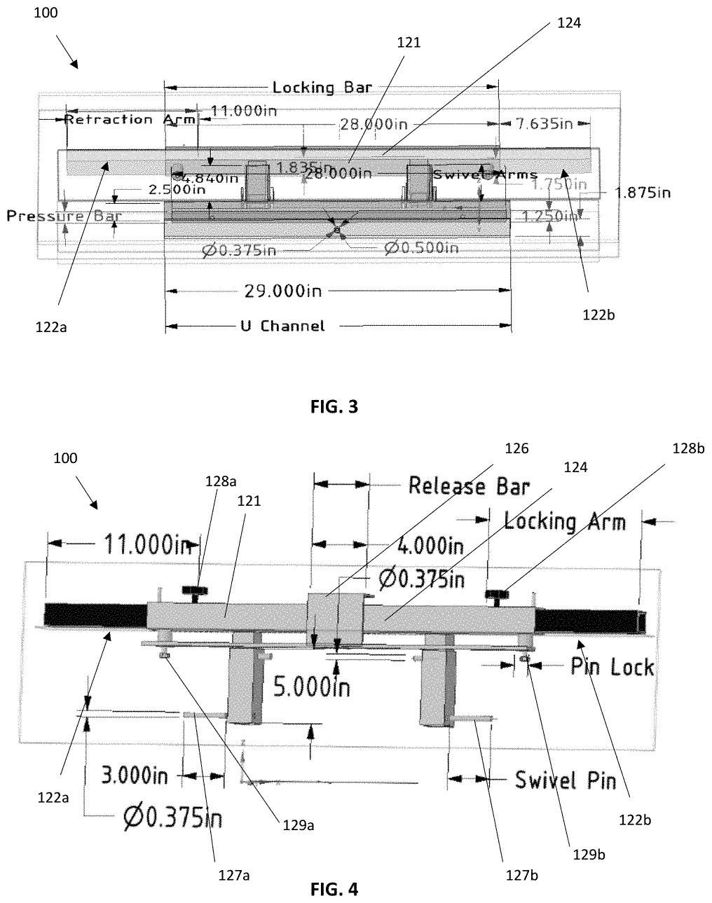

FIG. 1 illustrates a top view of the barricade 100 and FIG. 2 shows a perspective view of the barricade 100 illustrated in FIG. 1. FIG. 3 shows a bottom view of the barricade 100 illustrated in FIGS. 1 and 2. As shown in FIG. 3, the mounting portion 110 of the barricade 100 includes a steel U-channel 112 having a dimension of 2.5″×2″×29″. Inside the U-Channel 112 is a ¼″W×1¼″ H×28″L steel pressure bar 114 which has two ⅜″D steel guide pins 1161, 116b which slide through the U Channel to allow adjustment of barricade 100 to doors having different thicknesses. In some embodiments, the U-Channel 112 may have pressure screws 118a, 118b with knobs that tighten against the pressure bar 114 to attach the telescoping door barricade 100 to the door. In select embodiments, the U-Channel 112 may have (4) steel brackets with ⅜″ diameter holes which allow two 1½″ female square tubing that swivels upward 90 degrees parallel to the door.

As shown in FIG. 2, the locking portion 120 of the barricade 100 may, in some embodiments, be attached to the mounting portion 110 with two 1½″ square male tubes 130a, 130b welded to a locking bar 124 and affixed to the U-Channel 112 using two ⅜″ steel pins (not shown). The male tubes 130a, 130b may have ⅜″ drilled holes equally spaced, allowing telescoping door barricade 100 to accommodate various door jamb thicknesses through the movement of two ⅜″ steel pins.

As shown in FIG. 3, the locking bar 124 may be formed of 1¾″ square steel tubing with an inside dimension of 1½″ and is 28″ in length. Inserted in the lock bar 124 there may be two 11″×1½″ square tubes positioned at opposite ends of the locking bar 124. The front face of the locking bar 124 may have two 8″ slots equally distanced from each end of the locking bar 124, thereby limiting the travel of the telescoping locking arms 122a, 122b, which are spring loaded. Each of the telescoping arms 122a, 122b has a 2″×⅜″ may include threaded knob 128a, 128b, which limits the travel and allows for easy retraction of the arms 122a, 122b into the frame 121. The rear face of the locking bar 124 may include two ⅜″ Pin Locks 129a, 129b that capture the spring-loaded telescoping arms 122a, 122b when the barricade 100 is in an unlocked position. The Pin Locks may be released by a user using a release bar 126 which when pushed allows features of the telescoping arms 122a, 122b (completely or partially) to extend from the frame 121 (see FIGS. 3 and 4).

The illustration in FIG. 4 shows a detailed view of an exemplary swivel locking mechanism for an outward opening door barricade device 100. In particular, FIG. 4 shows the barricade 100 in an unlocked position, with telescoping arms 122a, 122b freely moveable relative to frame 121. In FIG. 4, the spring-activated telescoping arms 122a, 122b can telescope from the frame 121 after the release bar 126 is pushed. These arms 122a, 122b will lock against adjacent walls, effectively making the door to which the barricade is mounted and the adjacent walls attached. The telescoping arms 122a, 122b can be easily reversed from the inside of the room by sliding back the threaded knobs 128a, 128b. The arms 122a, 122b are held in place by two pin locks 129a, 129b when the barricade is in the unlocked position.

In some embodiments, the mounting portion 110 is pivotally attached to the locking portion 120 with swivel pins 127a, 127b. This type of pivotable connection can be helpful for configurations in which the door is not co-planar with the adjacent walls. For example, if the walls extend farther into the room than the door, the barrier 100 needs to extend from the door to reach the adjacent walls. Using swivel pins 127a, 127b to attach the mounting portion 120 to the locking portion 120 can allow the locking potion 120 to be stowed close to the door when the barricade 100 is in an unlocked position and, when positioning the barricade 100 into a locked position, position the locking portion 120 sufficiently close to the adjacent walls for the telescoping arms 122a, 122b to extend in front of the walls.

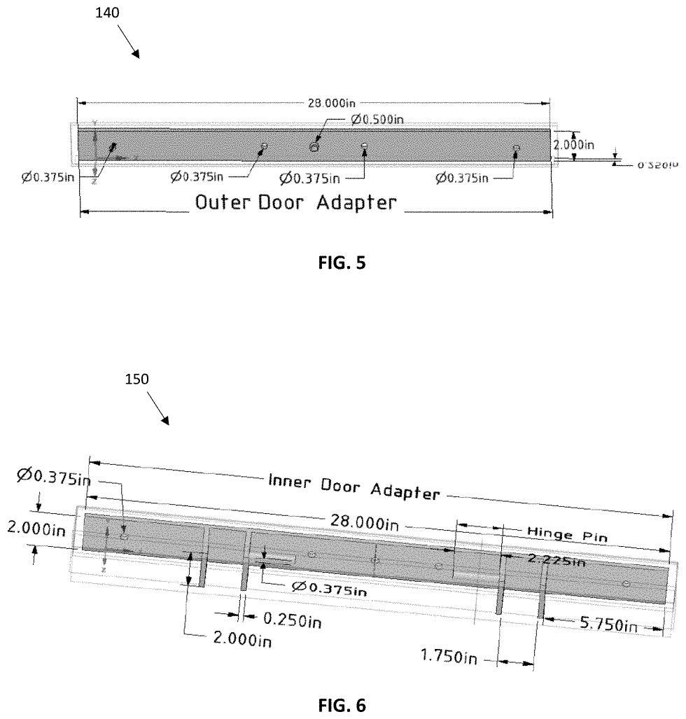

FIG. 5 illustrates an exemplary outer door adapter 140 and FIG. 6 illustrates an exemplary inner door adapter 150. The disclosed outer door adapter 140 and/or inner door adapter 150 may be used in situation where there is insufficient clearance between the bottom edge of the door and the surface of the floor for the mounting portion 110 illustrated in FIGS. 1-4 to be used. In embodiments in which adapter 140 and/or 150 is used, the door may be drilled and four ⅜″×3½″ bolts and nuts may be used to secure the locking portion 120 to the door. The adapters 140, 150 must first be centered on the bottom face of the door before drilling. The locking portion 120 may then be connected to the adapter 140/150 with two ⅜″×3″ swivel pins.

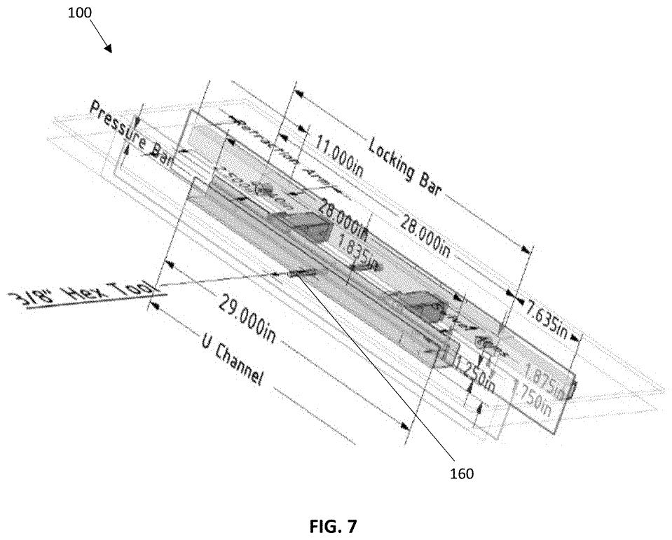

FIG. 7 illustrates an exemplary hex tool 160 interfacing with the barricade 100 previously described herein. The hex tool 160 may, in some embodiments, be a ⅜″ Hex Tool, which may be used in an emergency entrance scenario, if needed. The Hex Tool 160 may be used to retract the Telescoping Arms 122a, 122b into the frame 121 by turning a ratcheting mechanism which pulls nylon straps to retract the arms 122a, 122b.

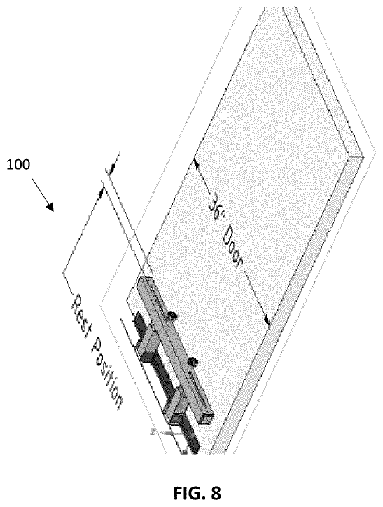

FIG. 8 shows the exemplary barricade device 100 (as previously described) in an unlocked position, folded up parallel to the door.

Upon consideration of the subject disclosure, it should be appreciated that various embodiments of the disclosed telescoping door barricades for outward opening doors may include a Steel U-Channel or optional adapter plates, various steel telescoping tubing components, and a folding locking bar with spring-loaded telescoping locking arms. The U-Channel may have a thickness less than the distance between the floor and bottom edge of the door. This can allow for the steel U-Channel to slide under an outward opening door while opened. The disclosed telescoping door barricade may then be centered on the door and affixed to the bottom of the door with threaded knobs tightened against a pressure bar securing the barricade to the door. The swiveling telescoping tubing may then be adjusted to the width of the distance between the door and the inside wall by moving the two ⅜″ locking pins. The barricade may thus be permanently adjusted. The disclosed barricade can now be rotated 90 degrees upward to the rest position. When needed in a hostile situation, the barricade can be activated simply by closing the door, fold down the barricade, and push the release bar securing the room from outside threats. The disclosed barricade devices are quick and easy to use when seconds can save human life. There is no need to look for wedges, adjustment bars, or other barricading devices, which take considerable time to engage.

### Exemplary Barricades for Inward-Opening Doors

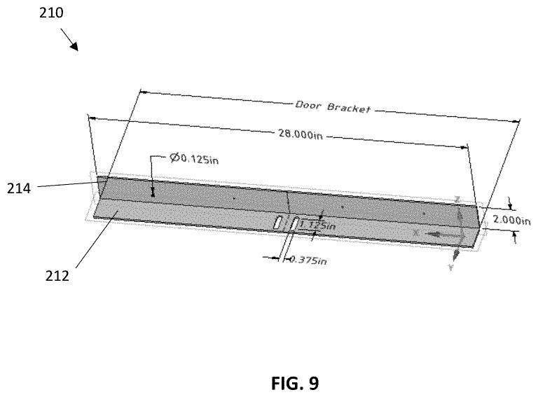

Exemplary barricade assemblies for one or more inward-opening doors are described herein. FIG. 9 illustrates an example inner door bracket 210 for an inward opening single door barricade assembly 200. As shown in FIG. 9, the inner door bracket 210 includes a first planar surface 212 positioned at a 90 degree angle to a second planar surface 214. In some embodiments, the first planar surface 202 and the second planar surface 214 are implemented with a rigid material, such as stainless steel. The first planar surface 212 and the second planar surface 214 are joined together, for example, by welding. In some embodiments, the first planar surface 212 and the second planar surface 214 may be formed of a single material bent into the shape as shown in FIG. 9.

The inner door bracket 210 may have any suitable dimensions. As shown in FIG. 9, the inner door bracket 200 may have an overall length of 28″, a width of 1.125 inches, and a height of 2.0 inches. In some such embodiments, the width of the first planar surface 212 defines the overall width of the inner door bracket 210 and the width of the second planar surface 214 defines the overall height of the inner door bracket 210. In some embodiments, the inner door bracket 210 includes three magnets. In some such embodiments, the magnets may have a strength of at least or approximately 90 pounds each. The inner door bracket 210 may include holes or apertures to allow the inner door bracket 210 to be secured to a door.

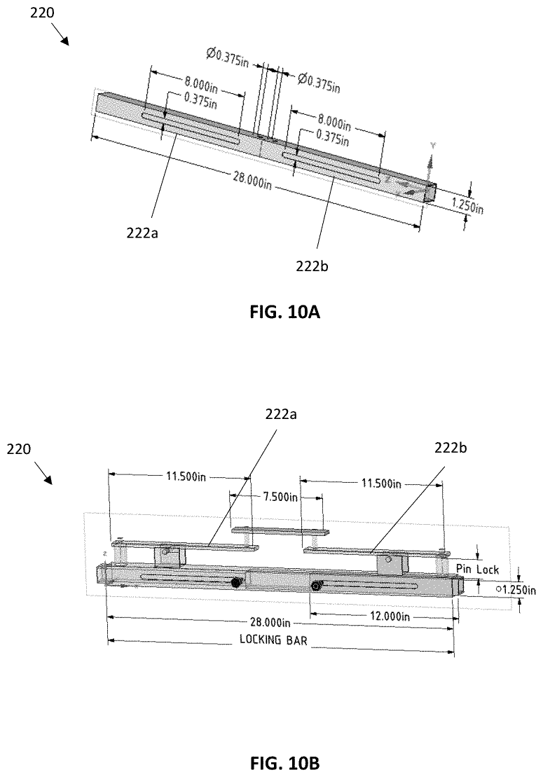

The disclosed inner door bracket 210 may, in some embodiments, be configured to interface with a locking bar assembly 220. In particular, the inner door bracket 210 may be configured to attach to the locking bar assembly to effectively attach the locking bar assembly 220 to a door. FIG. 10A illustrates an exemplary locking bar assembly 220. In some embodiments, the locking bar assembly 220 may be implemented with a piece of square steel tubing. In some such embodiments, the square steel tubing may have a length of 28 inches, a width of 1.5 inches, and a height of 1.5 inches. The locking bar assembly 220 may be formed of two square tubing arms 222a, 222b, as illustrated in FIG. 10A. Each square tubing arm 222a, 222b may have dimensions of 12″×1.25″×1.25″, in some embodiments. The square tubing arms 222a, 222b may each be spring loaded and held in place by two pin locks welded on opposing ends of the locking bar assembly 220.

The locking bar assembly 220 may have some or all of the features previously described herein with respect to the locking portion 120 of barricade 100. In some embodiments, the spring loaded square tubing arms 222a, 222b can be released by pushing a release lever that releases the arms, allowing them to travel through one or more inner door brackets 210 mounted to a wall and locking the door to the wall.

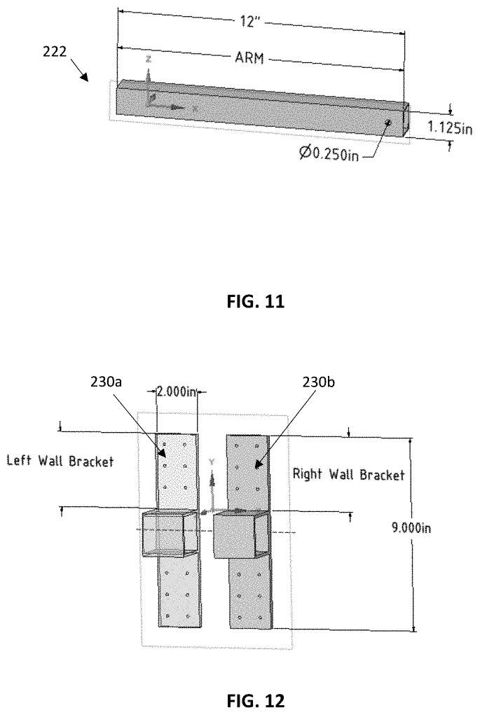

FIG. 10B illustrates an exploded view of an exemplary locking bar assembly 220 shown in FIG. 10A in which features of the spring-loaded square tubing arms 222a and 222b are shown. FIG. 11 illustrates an exemplary spring-loaded square tubing arm 222 of a locking bar assembly 220. The spring-loaded square tubing arm may have any suitable dimensions, including a length of approximately twelve inches, a width and height of approximately 1.125 inches, and a wall thickness of approximately 0.25 inches.

The disclosed barricade assembly 210 may, in some embodiments, include one or more left wall brackets and one or more right wall brackets. FIG. 12 illustrates an exemplary left wall bracket 230a and an exemplary right wall bracket 230b. As will be appreciated, the left wall bracket 230a and the right wall bracket 230b, if present, may be configured to receive and retain the spring-loaded tubing arms 222a, 222b of the locking bar assembly 220.

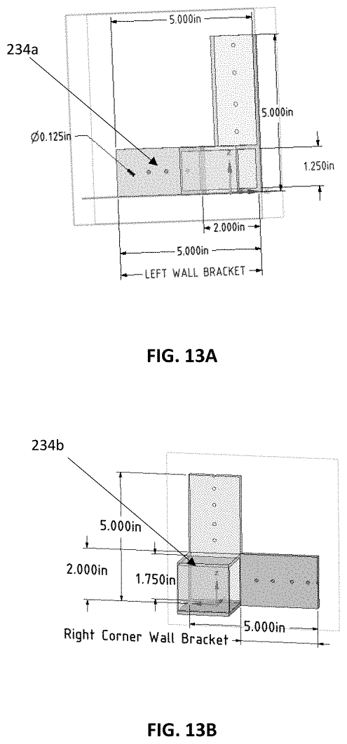

In some embodiments, the locking bar assembly 210 may be mounted on a door just under the door knob. In some such embodiments, left wall bracket 230a and/or right wall bracket 230b may be used to receive and retain features of the locking bar assembly 210. In other embodiments, the locking bar assembly 210 may be mounted at the bottom of the door using one or more corner wall brackets 234a, 234b, illustrated in FIGS. 13A and 13B. FIG. 13A illustrates an exemplary left wall corner bracket 234a and FIG. 13B illustrates an exemplary right wall corner bracket 234b.

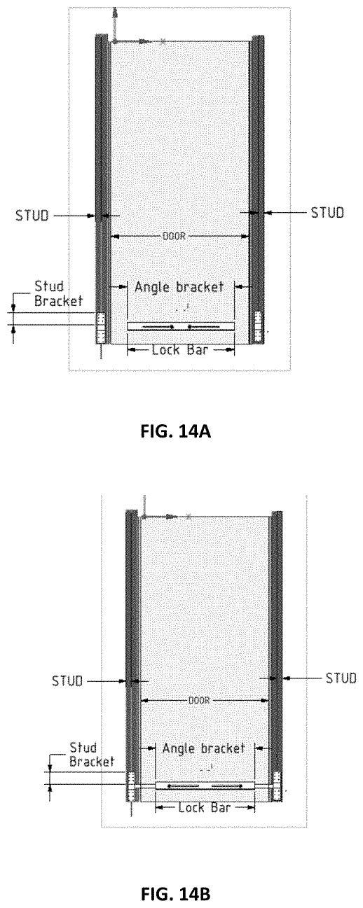

FIGS. 14A-14B show an example locking bar assembly, with FIG. 14A showing the locking bar assembly in an unlocked position and FIG. 14B showing the locking bar assembly in a locked position. Although FIGS. 14A and 14B illustrate the locking bar assembly on a bottom portion of the door, it will be appreciated that the locking bar assembly can be placed in any suitable position on a door, including in a middle portion of a door or on a top portion of the door. Numerous possibilities are possible and contemplated herein.

### Exemplary Barricade Devices for Double Doors

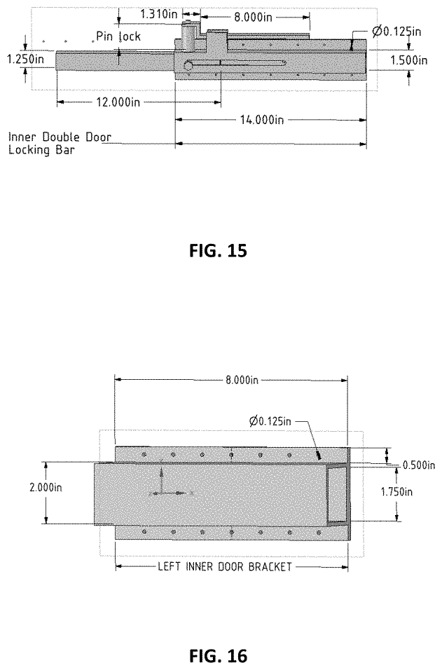

FIG. 15 illustrates an exemplary barricade for double doors. As shown in FIG. 15, the exemplary barricade for double doors may, in some embodiments, include a right door telescoping locking bar and a left door receiving bracket. FIG. 15 illustrates an example Right Door Telescoping Locking Bar that includes a 14″L×1½″×1½″ square tube with 1″ flanges and a 8″×⅜″ slot allowing for the 12″×1¼″×1¼″ extension of the spring loaded telescoping arm.

FIG. 16 illustrates an example Left Door Receiving Bracket with an 8″L×2″×2″ square steel tubing with ½″ flanges with ⅛″ holes allowing attachment to the door.

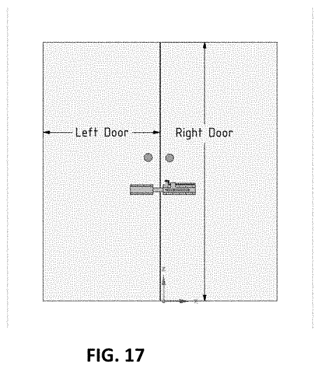

As will be appreciated by one skilled in the art upon consideration of the subject disclosure, the disclosed Telescoping Door Barricade for double doors can be used either on inward or outward opening double doors. The device can be mounted anywhere on the inside of the doors. FIG. 17 shows the device mounted in the middle of the doors, for example.

### Additional Features

The disclosed telescoping door barricade devices simple to use with minimal actions needed to secure any room with an outward or inward-opening single or double door. The disclosed barricade devices can be easily installed, for example, by using the following method: (1) slide the device under an opened door, (2) center on door, (3) tighten the locking screws, (4) close the door, (5) fold down the device, (6) adjust the two telescoping sleeves to the width of the wall using locking pins. The Telescoping Door Barricade is now completely installed. Using this method there is no need for tools. However, there are optional methods of installing the device by drilling the door and using adapter plates. When drilling, the device can be utilized anywhere on the inside face of the door. In addition, using the installation method that does not require tools, but a ⅜″ hole may be drilled through the door at a camouflaged position on the device allowing for emergency entry using a ⅜″ hex tool.

The disclosed devices can be bolted to the door by the use of two adapter plates when there is not sufficient floor clearance. The adapter plates may include: (a) an Outer Plate which is ¼″×1-½″×28″ with four ⅜″ predrilled holes and a ½″ boss with a ⅜″ center hole which is centered on the 28″ plate. This allows for emergency access; (b) Inner Plate, (c) Through Bolts and Nuts. The inner plate may also have the same dimensions as the outer plate but may have receiving brackets to accommodate the pivoting telescoping tubing and locking mechanism.

The telescoping arms of the disclosed barricade devices can be activated by any suitable mechanical force, including the use of Springs, Hydraulic, pneumatic, Electronic or magnetic forces. The disclosed telescoping door barricade are fully adjustable to the distance from the inside face of the door to the adjacent wall by telescoping adjustment sleeves.

The barricade devices can be activated to the locked position seconds. The devices can also be deactivated in one motion by simply sliding back the telescoping arms to the unlocked position. This is an important factor because it meets International Fire Code 2003 and 2006 edition section 1008.1.8.5, IFC 2009 section 1008.1.5.

In some embodiments, the disclosed barricade devices can be opened in case of an emergency from the outside of the door through a camouflaged hole and use of a special tool. In some embodiments, the disclosed barricades may include features, such as a motion sensor with GPS mounted to the device that signals Police and Fire (911) when the device is activated. The devices can be configured to alert other barricades within the building that a threat is present by use of sound and/or flashing lights.

The disclosed barricade devices can be incorporated on steel doors, wood doors, bulletproof glass doors, jail doors, or any type of door. When not in use, the barricade may be folded up parallel to the door and folded down 90 degrees to engage with the wall in a locked position.

As will be appreciated, the presently disclosed barricades may provide numerous advantages. For example, the disclosed telescoping door barricades may be mount on any outward opening door in minutes, in some cases without any tools. The disclosed telescoping door barricades can be pre-installed on new doors, if desired. The telescoping door barricades can be folded up against the door when not in use. The telescoping door barricade can be folded down easily.

The telescoping door barricade may be activated with a simple push of a release bar with a hand or foot. The disclosed barricades can be activated within seconds. When activated, the barricade essentially locks to the door to the wall. After activation, the barricaded door can't be opened from the outside by conventional means. The barricades may be adjustable to door thickness and/or wall thickness.

The barricade devices can easily be reversed from the inside of the room by simply retracting the arms with the retracting knobs returning them to the dormant position in one motion.

What is claimed is:

1. A barricade comprising:
a mounting portion configured to be fixedly mounted on a door; and
a locking portion attached to the mounting portion, the locking portion comprising:
a frame having a first telescoping arm and a second telescoping arm contained therein, wherein the first telescoping arm is arranged to extend from the frame in a first direction and the second telescoping arm is arranged to extend from the frame in a second direction opposite the first direction.

2. The barricade of claim 1, wherein the barricade is configured to adopt both a locked position and an unlocked position and in the unlocked position, the first telescoping arm and the second telescoping arm are each retained fully or partially inside the frame and in the locked position, the first telescoping arm and the second telescoping arm each extend farther beyond the frame than in the unlocked position.

3. The barricade of claim 1, wherein the mounting portion further includes a steel U-channel.

4. The barricade of claim 3 further comprising a steel pressure bar inside the U-channel and at least two steel guide pins slidably inserted in the U-channel.

5. The barricade of claim 4 further comprising at least two pressure screws with knobs to tightly fit the pressure bar to the door.

6. The barricade of claim 1, wherein the first telescoping arm and the second telescoping arm are each spring-loaded.

7. The barricade of claim 6, wherein the locking portion further comprises a first pin lock secured in the frame and positioned to retain the first telescoping arm when the barricade is in an unlocked position and a second pin lock secured in the frame and positioned to retain the second telescoping arm when the barricade is in an unlocked position.

8. The barricade of claim 7 further comprising a release bar on the frame that, when activated, releases the first telescoping arm from the first pin lock and simultaneously releases the second telescoping arm from the second pin lock.

9. The barricade of claim 1, wherein the mounting portion is pivotally attached to the locking portion with two or more swivel pins.

10. The barricade of claim 1, wherein the barricade is mounted to a side of the door that opens outwardly from a room.

11. A barricade assembly comprising:
an inner door bracket having a first planar surface attached to a second planar surface, wherein the inner door bracket is configured to be mounted to a door; and
a locking bar assembly secured to the inner door bracket, the locking bar assembly comprising;
a first telescoping arm configured to extend out from the locking bar assembly in a first direction;
a second telescoping arm configured to extend out from the locking bar assembly in a second direction opposite the first direction; and
a release bar in communication with the first telescoping arm and the second telescoping arm such that when the release bar is engaged, the first telescoping arm and the second telescoping arm move from an unlocked position to a locked position.

12. The barricade assembly of claim 11, wherein the first telescoping arm and the second telescoping arm are spring-loaded.

13. The barricade assembly of claim 11 further comprising a left wall bracket configured to retain features of the first telescoping arm in the locked position.

14. The barricade assembly of claim 13 further comprising a right wall bracket configured to retain features of the second telescoping arm in the locked position.

15. The barricade assembly of claim 11, wherein the inner door bracket further comprises a plurality of magnets and the magnets secure the locking bar assembly to the inner door bracket.

16. The barricade assembly of claim 11, wherein the first planar surface and the second planar surface are positioned at an angle of 90°.

17. The barricade assembly of claim 11, wherein the inner door bracket and the locking bar assembly are mounted to a side of the door that opens inwardly into a room.
